(19) United States
(12) Patent Application Publication
(10) Pub. No.: US 2020/0191055 A1
(43) Pub. Date: Jun. 18, 2020

(54) TWIN-SPOOL TURBOJET ENGINE HAVING A LOW-PRESSURE SHAFT THRUST BEARING POSITIONED IN THE EXHAUST CASING

(71) Applicant: SAFRAN AIRCRAFT ENGINES, Paris (FR)

(72) Inventors: Guillaume Patrice KUBIAK, Moissy- Cramayel (FR); Nils Edouard Romain BORDONI, Moissy- Cramayel (FR); Michel Gibert Roland BRAULT, Moissy- Cramayel (FR); Romain Guillaume CUVILLIER, Moissy- Cramayel (FR); Arnaud Nicolas NEGRI, Moissy- Cramayel (FR); Nathalie NOWAKOWSKI, Moissy- Cramayel (FR)

(73) Assignee: SAFRAN AIRCRAFT ENGINES, Paris (FR)

(21) Appl. No.: 16/641,337

(22) PCT Filed: Aug. 24, 2018
(86) PCT No.: PCT/FR2018/052101

§ 371 Date: Feb. 24, 2020

(30) Foreign Application Priority Data
Aug. 25, 2017 (FR) 1757881

(51) Int. Cl. F02C 7/06; F02K 3/04

(52) U.S. Cl. CPC F02C 7/06; F05D 2220/323; F05D 2240/52; F02K 3/04

(57) ABSTRACT

A twin-spool turbojet engine includes: a low-pressure spool having a low-pressure compressor, a low-pressure turbine, and a low-pressure shaft connecting the low-pressure turbine to the low-pressure compressor; an exhaust casing through which exhaust gases flow downstream of the low-pressure turbine; and a low-pressure shaft thrust bearing having an inner ring and an outer ring, one of the rings being fastened on the low-pressure shaft and the other of the rings being fastened on the exhaust casing.

### FIELD OF THE INVENTION

The invention relates to a twin-spool turbojet engine, and more particularly to a double flow twin-spool geared turbojet engine having a high bypass ratio (turbofan).

### PRIOR ART

FIGS. 1 and 2 schematically show an example of a double flow twin-spool geared turbojet engine 1.

The turbojet engine 1 illustrated in these figures comprises a fan 2, a low-pressure spool 3, a high-pressure spool 4, a combustion chamber 5 and a gas exhaust nozzle 6.

The high-pressure spool 4 comprises a high-pressure compressor 41, a high-pressure turbine 42 and a high-pressure shaft 43 coupling the high-pressure turbine 42 to the high-pressure compressor 41.

The low-pressure spool 3 comprises a low-pressure compressor 31, a low-pressure turbine 32 and a low-pressure shaft 33 coupling the low-pressure turbine 32 to the low-pressure compressor 31, and extending inside the high-pressure shaft 43.

The high-pressure turbine 42 drives the high-pressure compressor 41 in rotation via the high-pressure shaft 43, while the low-pressure turbine 32 drives the low-pressure compressor 31 and the fan 2 in rotation via the low-pressure shaft 33.

The turbojet engine 1 illustrated in FIGS. 1 and 2 is a double flow turbojet engine having a high bypass ratio, the bypass ratio being defined as the ratio between the flow rate of the secondary (cold) flow B and the flow rate of the primary (hot) flow A.

To achieve such a bypass ratio, the fan 2 is decoupled from the low-pressure turbine 32, thus allowing to independently optimize their respective speeds of rotation. The decoupling is for example obtained using a reduction gearing 7, such as an epicyclic gearing, disposed between the upstream end of the low-pressure shaft 33 and the fan 2. The fan 2 is driven by the low-pressure shaft 33 via the reduction gearing 7 and an additional shaft 23, called the fan shaft.

This decoupling allows reducing the speed of rotation of the fan and the fan pressure ratio, and thus increasing the power extracted by the low-pressure turbine. Thanks to the reduction gearing, the low-pressure shaft can rotate at speeds of rotation higher than in conventional turbojet engines.

This disposition allows improving the propulsion efficiency of the turbojet engine and reducing its fuel consumption, as well as the noise emitted by the fan.

As illustrated in FIGS. 1 and 2, the fan shaft 23, the low-pressure shaft 33 and the high-pressure shaft 43 are guided in rotation relative to the structural portions of the turbojet engine 1 (these structural portions in particular including the inlet casing, the inter-compressor casing, the inter-turbine casing and the exhaust casing) by means of various bearings.

More specifically, each shaft is supported by a first bearing (or thrust bearing), capable of withstanding both radial forces and axial forces exerted on the shaft, and by one or more additional bearing(s) capable of withstanding only radial forces exerted on the shaft.

Particularly, in FIGS. 1 and 2, the fan shaft 23 is supported by a first fan bearing S#1 (upstream bearing) and a second fan bearing S#2 (downstream bearing) disposed between the fan shaft 23 and the inlet casing 8. In the example illustrated in FIGS. 1 and 2, the second bearing S#2 is a “thrust” bearing, that is to say it is capable of withstanding the axial forces exerted (upstream) by the fan 2 on the fan shaft 23.

The low-pressure shaft 33 is supported by four bearings, including a first bearing BP#1, disposed between the low-pressure shaft 33 and the inlet casing 8 (in the proximity of the upstream end of the low-pressure shaft), a second bearing BP#2 disposed between the low-pressure shaft 33 and the inter-compressor casing 9, a third bearing BP#3, disposed between the low-pressure shaft 33 and the inter-turbine casing 10, and a fourth bearing BP#4, disposed between the low-pressure shaft 33 and the exhaust casing 11. The first bearing BP#1 is a “thrust” bearing, that is to say it is capable of withstanding the axial forces exerted (downstream) by the low-pressure turbine 3 on the low-pressure shaft 33.

The high-pressure shaft 43 is supported by three bearings, including a first bearing HP#1, disposed between the high-pressure shaft 43 and the inter-compressor casing 9 (in the proximity of the upstream end of the high-pressure shaft), a second bearing HP#2 disposed between the high-pressure shaft 43 and the inter-compressor casing 9, a third bearing HP#3, disposed between the high-pressure shaft 43 and the inter-turbine casing 10. The first bearing HP#1 is also a “thrust” bearing, that is to say it is capable of withstanding the axial forces exerted (downstream) by the high-pressure turbine 41 on the high-pressure shaft 43.

In such an architecture, due to the presence of the reduction gearing 7 and the decoupling of the fan 2 and the low-pressure turbine 32, the axial forces exerted by the low-pressure turbine 32 are not compensated by the axial forces exerted by the fan 2. As a result, the first bearing BP#1 must be dimensioned to withstand high axial forces. Consequently, this bearing has a significant space requirement.

However, the space requirement of the first bearing BP#1 makes it difficult to integrate this bearing into the center of the low-pressure compressor 31.

Furthermore, the integration of the reduction gearing 7 and the bearing BP#1 requires modifying the shape of the primary flow path serving to guide the primary flow A.

### SUMMARY OF THE INVENTION

A purpose of the invention is to provide a twin-spool turbojet engine having an arrangement which facilitates the integration of the low-pressure shaft thrust bearing within the turbojet engine.

This purpose is achieved in the context of the present invention thanks to a twin-spool turbojet engine comprising:
a high-pressure spool, comprising a high-pressure compressor, a high-pressure turbine and a high-pressure shaft connecting the high-pressure turbine to the high-pressure compressor,
a low-pressure spool, comprising a low-pressure compressor, a low-pressure turbine and a low-pressure shaft connecting the low-pressure turbine to the low-pressure compressor, the low-pressure shaft extending inside the high-pressure shaft,
a fan shaft,
a reduction mechanism coupling the low-pressure shaft and the fan shaft,
an exhaust casing through which exhaust gases flow downstream of the low-pressure turbine,

the turbojet engine being characterized in that it further comprises a low-pressure shaft thrust bearing comprising an inner ring and an outer ring, one of the rings being fastened on the low-pressure shaft and the other of the rings being fastened on the exhaust casing.

In such an arrangement, the low-pressure shaft thrust bearing can be disposed in the proximity of the downstream end of the low-pressure shaft, in the center of the exhaust casing, where more space is available.

This arrangement can also allow the removal of one or more low-pressure bearing(s) (for example the fourth bearing BP#4 in FIGS. 1 and 2).

Finally, this arrangement allows reducing the relative axial displacements between the rotor and the stator of the low-pressure turbine due to the expansions of the various parts of the turbojet engine when the latter is in operation.

Moreover, the proposed arrangement allows not to modify the shape of the primary flow path.

The proposed turbojet engine can further have the following characteristics:
the turbojet engine can further comprise at most two additional low-pressure shaft bearings, each additional low-pressure shaft bearing comprising an inner ring and an outer ring, one of the rings being fastened on the low-pressure shaft and the other of the rings being fastened on a casing of the turbojet engine,
the turbojet engine may further comprise a single additional low-pressure shaft bearing, the additional low-pressure shaft bearing comprising an inner ring and an outer ring, one of the rings being fastened on the low-pressure shaft and the other of the rings being fastened on a casing of the turbojet engine,
each additional low-pressure shaft bearing may comprise an inner ring or an outer ring fastened on an inter-compressor casing or an inter-turbine casing of the turbojet engine,
the low-pressure compressor can comprise:
a low-pressure compressor casing having an inner surface delimiting a flow path of an air flow through the low-pressure compressor,
a stator comprising blades mounted stationary relative to the low-pressure compressor casing and extending in the flow path of the air flow, and
a rotor comprising movable blades capable of being driven in rotation relative to the stator by the low-pressure shaft, the movable blades extending in the flow path of the air flow while being interposed between the stationary blades,
the inner surface of the low-pressure compressor casing, the stationary blades and the movable blades being disposed relative to each other so as to allow an axial displacement of the movable blades relative to the stationary blades parallel to the axis of rotation of the low-pressure shaft,
   the authorized axial displacement can be comprised between 1 millimeter and 2 centimeters, preferably between 2 millimeters and 1 centimeter,
   in one embodiment, the inner surface of the low-pressure compressor casing may have, between the stationary blades, portions of cylindrical shape of revolution, having the axis of rotation of the low-pressure shaft as their axis of revolution,
   in another embodiment, the inner surface of the low-pressure compressor casing may have a cylindrical shape of revolution, having the axis of rotation of the low-pressure shaft as its axis of revolution,
   the low-pressure shaft may have an upstream end provided with splines and the reduction mechanism may comprise an input shaft having an end provided with splines, the splines of the input shaft of the reduction mechanism cooperating with the splines the low-pressure shaft so as to secure the two shafts in rotation while allowing a translation of one of the shafts relative to the other,
   the low-pressure compressor comprises an upstream disc of a low-pressure compressor having a bore having a first radius, and in which the first low-pressure shaft thrust bearing has a second radius such that: D2>0.70×D1, preferably D2>0.75×D1, where D1 is the first radius and D2 is the second radius,
   the turbojet engine further comprises a second low-pressure shaft thrust bearing comprising an inner ring and an outer ring, one of the rings being fastened on the low-pressure shaft and the other of the rings being fastened on the inlet casing,
   the low-pressure shaft comprises a low-pressure shaft upstream portion, a low-pressure shaft downstream portion, and a coupling assembly adapted to transmit a torque between the low-pressure shaft upstream portion and the low-pressure shaft downstream portion while allowing a relative axial displacement between the low-pressure shaft upstream portion and the low-pressure shaft downstream portion.

### PRESENTATION OF THE DRAWINGS

Other characteristics and advantages will also emerge from the description which follows, which is purely illustrative and non-limiting and should be read with reference to the appended figures, among which:

FIG. 1, already commented, schematically shows, in longitudinal section, an example of a conventional twin-spool turbojet engine,

FIG. 2, already commented, is a diagram schematically showing the arrangement of the different bearings in the turbojet engine of FIG. 1,

FIG. 3 schematically shows, in longitudinal section, a twin-spool turbojet engine in accordance with a first embodiment of the invention,

FIG. 4 is a diagram schematically showing the arrangement of the various bearings in the turbojet engine of FIG. 3,

FIG. 5 schematically shows, in longitudinal section, a twin-spool turbojet engine in accordance with a second embodiment of the invention,

FIG. 6 is a diagram schematically showing the arrangement of the various bearings in the turbojet engine of FIG. 5,

FIG. 7 schematically shows, in longitudinal section, a twin-spool turbojet engine in accordance with a third embodiment of the invention,

FIG. 8 is a diagram schematically showing the arrangement of the various bearings in the turbojet engine of FIG. 7,

FIG. 9 schematically shows, in longitudinal section, a twin-spool turbojet engine in accordance with a fourth embodiment of the invention,

FIG. 10 is a diagram schematically showing the arrangement of the various bearings in the turbojet engine of FIG. 9,

FIG. 11 schematically shows, in longitudinal section, a twin-spool turbojet engine in accordance with a fifth embodiment of the invention,

FIG. 12 is a diagram schematically showing the arrangement of the various bearings in the turbojet engine of FIG. 11,

FIG. 13 schematically shows, in longitudinal section, a twin-spool turbojet engine in accordance with a sixth embodiment of the invention,

FIG. 14 is a diagram schematically showing the arrangement of the various bearings in the turbojet engine of FIG. 13,

FIG. 15 schematically shows, in longitudinal section, a twin-spool turbojet engine in accordance with a seventh embodiment of the invention,

FIG. 16 is a diagram schematically showing the arrangement of the various bearings in the turbojet engine of FIG. 15,

FIG. 17 schematically illustrates the arrangement of the stationary blades and the movable blades in a conventional low-pressure compressor casing,

FIG. 18 schematically shows the arrangement of the stationary blades and the movable blades in a low-pressure compressor casing, in accordance with a first possibility,

FIGS. 19 and 20 schematically show the arrangement of the stationary blades and the movable blades in a low-pressure compressor casing, in accordance with a second possibility,

FIG. 21 schematically shows, in longitudinal section, a twin-spool turbojet engine in accordance with an eighth embodiment of the invention,

FIG. 22 schematically shows, in longitudinal section, a first coupling assembly,

FIG. 23 schematically shows, in longitudinal section, a second coupling assembly.

### DETAILED DESCRIPTION OF THE EMBODIMENTS

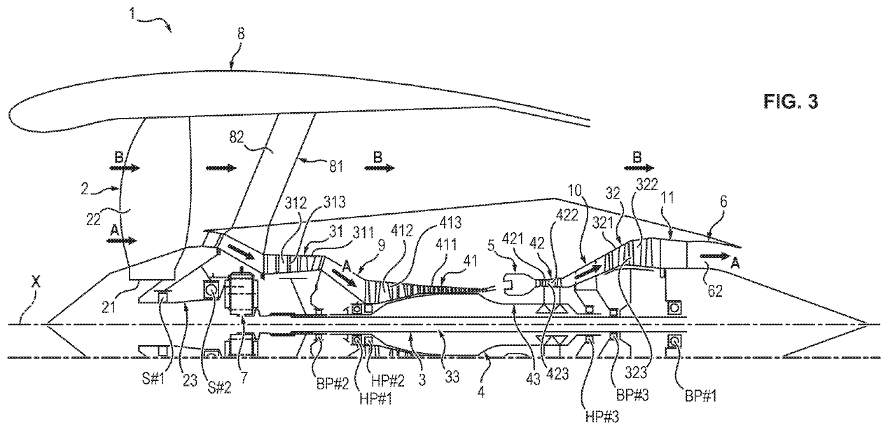

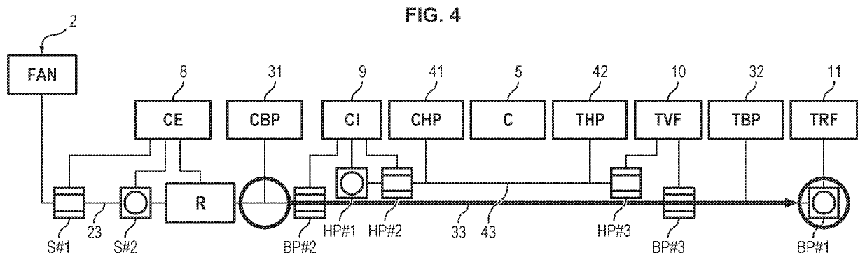

In FIGS. 3 and 4, the turbojet engine 1 shown comprises a fan 2, a low-pressure spool 3, a high-pressure spool 4, a combustion chamber 5 and a gas exhaust nozzle 6.

The fan 2 comprises a fan disc 21 provided with fan blades 22 at its periphery which, when they are rotated, drive the air flow in the primary and secondary flow spaces of the turbojet engine 1.

The low-pressure spool 3 comprises a low-pressure compressor 31, a low-pressure turbine 32 and a low-pressure shaft 33 coupling the low-pressure turbine 32 to the low-pressure compressor 31.

The high-pressure spool 4 comprises a high-pressure compressor 41, a high-pressure turbine 42 and a high-pressure shaft 43 coupling the high-pressure turbine 42 to the high-pressure compressor 43.

The low-pressure shaft 33 extends inside the high-pressure shaft 43. The low-pressure shaft 33 and the high-pressure shaft 43 are coaxial. The low-pressure shaft 33 and the high-pressure shaft 43 have as their axis of rotation, the axis X, which is also the longitudinal axis of the turbojet engine 1.

The high-pressure turbine 42 drives the high-pressure compressor 41 in rotation via the high-pressure shaft 43, while the low-pressure turbine 32 drives the low-pressure compressor 31 and the fan 2 in rotation via the low-pressure shaft 33.

The expression “twin-spool” means that the turbojet engine comprises only two spools (spools 2 and 3), each spool consisting of a compressor, a turbine and a shaft coupling the turbine to the compressor. A twin-spool turbojet engine is distinguished, for example, from a “triple-spool” turbojet engine which comprises a low-pressure spool, a high-pressure spool and an intermediate spool interposed between the high-pressure spool and the low-pressure spool.

The turbojet engine 1 further comprises a fan shaft 23 and a reduction gearing 7, coupling the fan shaft 23 to the low-pressure shaft 33. The fan disc 21 is mounted stationary on the fan shaft 23 so that the fan disc 21 is driven in rotation by the low-pressure shaft 33 via the reduction gearing 7 and the fan shaft 23.

The low-pressure compressor 31 comprises a low-pressure compressor casing 311, a stator 312 and a rotor 313. The stator 312 comprises stator blades 314 mounted stationary on the casing 311. The rotor 313 comprises rotor blades 315 capable of being driven in rotation relative to the stator blades by means of the low-pressure shaft 33. To this end, the rotor blades are mounted stationary on the low-pressure shaft 33. The rotor blades extend in the flow path of the primary flow A while being interposed between the stationary blades.

Similarly, the high-pressure compressor 41 comprises a high-pressure compressor casing 411, a stator 412 and a rotor 413. The stator 412 comprises stator blades mounted stationary on the casing 411. The rotor 413 comprises rotor blades capable of being driven in rotation relative to the stator blades by means of the high-pressure shaft 43. To this end, the rotor blades are mounted stationary on the high-pressure shaft 43. The rotor blades extend in the flow path of the primary flow A while being interposed between the stationary blades.

The low-pressure turbine 32 comprises a low-pressure turbine casing 321, a stator 322 and a rotor 323. The stator 322 comprises stator blades mounted stationary on the casing 321. The rotor 323 comprises rotor blades capable of being driven in rotation relative to the stator blades by the exhaust gas flow. The rotor blades are mounted stationary on the low-pressure shaft 33. The rotor blades extend in the flow path of the primary flow A while being interposed between the stationary blades.

Likewise, the high-pressure turbine 42 comprises a high-pressure turbine casing 421, a stator 422 and a rotor 423. The stator 422 comprises stator blades mounted stationary on the casing 421. The rotor 423 comprises rotor blades capable of being driven in rotation relative to the stator blades by the exhaust gas flow. The rotor blades are mounted stationary on the high-pressure shaft 42. The rotor blades extend in the flow path of the primary flow A while being interposed between the stationary blades.

Moreover, the turbojet engine 1 comprises an inlet casing 8 (or intake casing) disposed around the fan 2. The inlet casing 8 comprises a rectifier 81 consisting of a series of stationary blades 82, disposed downstream of the fan 2 blades 22 and having the function of straightening the secondary flow B generated by the fan 2. The reduction gearing 7 is fixed on the inlet casing 8.

The turbojet engine 1 further comprises an inter-compressor casing 9 disposed between the low-pressure compressor 31 and the high-pressure compressor 41. More specifically, the inter-compressor casing 9 connects the low-pressure compressor 31 casing 311 to the high-pressure compressor 41 casing 411.

The inter-compressor casing 9 is provided to withstand the axial forces transmitted by the inlet casing 8, these axial forces being generated by the fan 2 on the fan shaft 23. The inter-compressor casing 9 transmits these axial forces to suspensions (not shown) by means of thrust take-up rods connecting the inter-compressor casing 9 to the suspensions.

The turbojet engine 1 further comprises an inter-turbine casing 10 disposed between the high-pressure turbine 42 and the low-pressure turbine 32. More specifically, the inter-turbine casing 10 connects the high-pressure turbine 42 casing 421 to the low-pressure turbine 32 casing 321.

The turbojet engine 1 further comprises an exhaust casing 11 and an exhaust nozzle 6 fixed to the exhaust casing 11. The exhaust nozzle 6 delimits a passage 62 for exhaust gases flowing downstream of the low-pressure turbine 32. The exhaust casing 11 is fixed to the low-pressure turbine 32 casing 321.

In operation, the air flow sucked by the fan 2 is divided into a primary flow A and a secondary flow B.

The secondary flow B successively passes through the fan 2 and the rectifier 81.

The primary flow A successively passes through the low-pressure compressor 31 and the high-pressure compressor 41. The pressurized air is injected into the combustion chamber 5 where it is used as an oxidant for the combustion of the fuel. The exhaust gas flow produced by the combustion reaction flows successively through the high-pressure turbine 42, the low-pressure turbine 32 and escapes from the turbojet engine 1 via the exhaust nozzle 6.

The exhaust gas flow drives the rotor 422 of the high-pressure turbine 42 and the rotor 322 the low-pressure turbine 32 in rotation. The rotor 422 of the high-pressure turbine 42 in turn drives the rotor 412 of the high-pressure compressor 41 by means of the high-pressure shaft 43, while the rotor 322 of the low-pressure turbine 32 drives the rotor 312 of the low-pressure compressor 31 by means of the low-pressure shaft 33. The rotor 322 of the low-pressure turbine 32 also drives the fan disc 21 by means of the reduction gearing 7 and the fan shaft 23.

As illustrated in FIGS. 3 and 4, the fan shaft 23 is supported by a first fan shaft bearing S#1 (upstream bearing) and a second fan shaft bearing S#2 (downstream bearing), each bearing being disposed between the fan shaft 23 and the inlet casing 8. The second bearing S#2 is a “thrust” bearing, that is to say it is capable of transmitting to the inlet casing 8 the axial forces exerted (upstream) by the fan 2 on the fan shaft 23.

In the first embodiment illustrated in FIGS. 3 and 4, the low-pressure shaft 33 is supported by three bearings BP#1, BP#2, BP#3.

The first bearing BP#1 is disposed between the low-pressure shaft 33 and the exhaust casing 11 (in the proximity of the downstream end of the low-pressure shaft 33).

The first bearing BP#1 is a “thrust” bearing, that is to say it is capable of transmitting the axial forces exerted (downstream) on the low-pressure shaft 33 to the exhaust casing 11.

More specifically, the thrust bearing BP#1 is capable of withstanding both radial forces and axial forces exerted on the low-pressure shaft 33. The thrust bearing BP#1 can be constituted by a ball bearing or a combination of several oblique contact or conical roller ball bearings which are adjacent disposed oppositely in an O or X configuration.

To this end, the thrust bearing BP#1 comprises an inner ring 351 fastened on the low-pressure shaft 33, an outer ring 352 fastened on the exhaust casing 11 and balls 353 or conical rollers disposed between the inner ring 352 and the outer ring 352.

The second bearing BP#2 is disposed between the low-pressure shaft 33 and the inter-compressor casing 9.

More specifically, the bearing BP#2 comprises an inner ring fastened on the low-pressure shaft 33, an outer ring fastened on the inter-compressor casing 9 and rollers disposed between the inner ring and the outer ring.

The third bearing BP#3 is disposed between the low-pressure shaft 33 and the inter-turbine casing 10.

More specifically, the bearing BP#3 comprises an inner ring fastened on the low-pressure shaft 33, an outer ring fastened on the inter-turbine casing 10 and rollers disposed between the inner ring and the outer ring.

Each of the upstream bearings BP#2 and BP#3 is capable of withstanding the radial forces exerted on the low-pressure shaft 33 while allowing a certain axial displacement of the low-pressure shaft 33 relative to the inter-compressor casing 9 and to the inter-turbine casing 10. This means that the bearings BP#2 and BP#3 do not transmit any axial force exerted on the low-pressure shaft 33 to the casings.

Indeed, during operation of the turbojet engine 1, the low-pressure shaft 33 undergoes an axial displacement relative to the inter-compressor casing 9 and to the inter-turbine casing 10 due to the expansion of some portions of the turbojet engine 1, in particular the high-pressure compressor 41, the combustion chamber 5, the high-pressure turbine 42 and the low-pressure turbine 32.

The bearings BP#2 and BP#3 are thus designed to be able to allow such axial displacement. To this end, each bearing BP#2 and BP#3 can be made of a roller bearing.

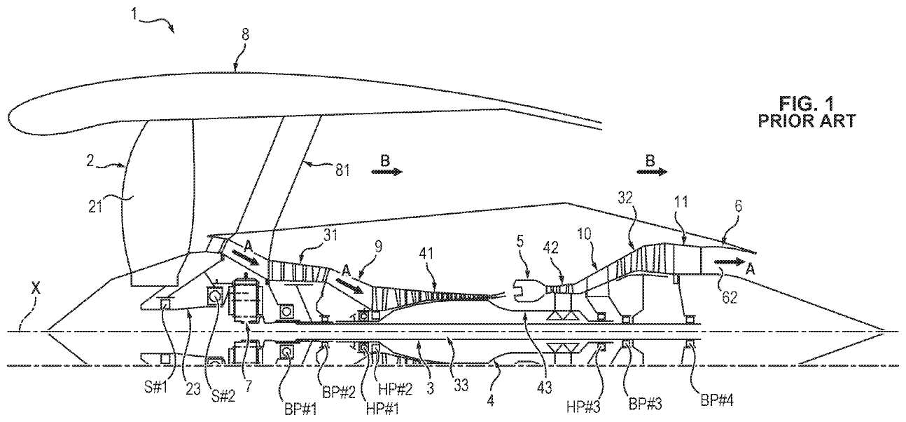

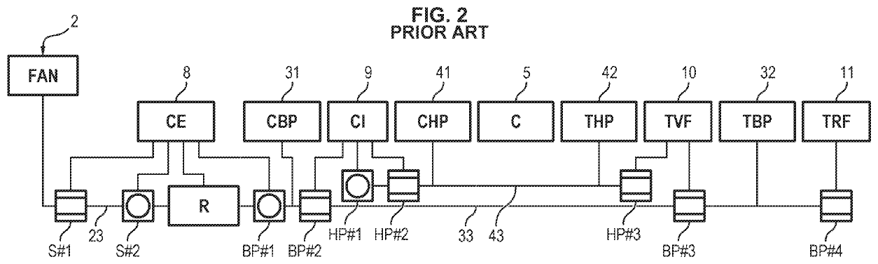

It will be noted that in the embodiment illustrated in FIGS. 3 and 4, the first bearing BP#1 replaces the fourth bearing BP#4 in FIGS. 1 and 2, so that only three bearings are necessary.

The high-pressure shaft 43 is also supported by three bearings HP#1, HP#2, HP#3.

In the embodiment illustrated in FIGS. 3 and 4, the first bearing HP#1 is disposed between the high-pressure shaft 43 and the inter-compressor casing 9 (in the proximity of the upstream end of the high-pressure shaft 43).

The first bearing HP#1 is a “thrust” bearing, that is to say it is capable of transmitting the axial forces exerted (downstream) on the high-pressure shaft to the inter-compressor casing 9.

More specifically, the thrust bearing HP#1 is capable of withstanding both radial and axial forces exerted on the low-pressure shaft 43.

The second bearing HP#2 is also disposed between the high-pressure shaft 43 and the inter-compressor casing 9, downstream of the first bearing HP#1.

The third bearing HP#3 is disposed between the high-pressure shaft 43 and the inter-turbine casing 10.

Just like the bearings BP#2 and BP#3, each of the bearings HP#2 and HP#3 is capable of withstanding radial forces exerted on the high-pressure shaft 43 while allowing a certain axial displacement of the high-pressure shaft 43 relative to the inter-compressor casing 9 and to the inter-turbine casing 10. This means that the bearings HP#2 and HP#3 do not transmit any axial force exerted on the high-pressure shaft 43.

The arrangement of the bearing BP#1 in the center of the exhaust casing 11 has the effect of preventing any relative axial displacement between the downstream end of the low-pressure shaft 33 and the exhaust casing 11.

This arrangement advantageously allows avoiding or limiting the axial displacement of the rotor blades relative to the stator blades of the low-pressure turbine 32, during operation of the turbojet engine 1.

It is therefore possible to axially bring the rotor blades closer to the stator blades, thus allowing a more compact turbine design.

Furthermore, this arrangement simplifies the design of dynamic sealing devices (generally consisting of wipers and coatings made of an abradable material located facing each other) necessary to prevent gas leaks between the rotor blades and the inner surface of the low-pressure turbine 32 casing 321. Indeed, only the leaks due to radial displacements must be prevented, axial displacements being eliminated.

On the other hand, when the turbojet engine 1 is in operation, due to the expansion of some portions of the turbojet engine, the upstream end of the low-pressure shaft 33 tends to axially displace relative to the low-pressure compressor 31 casing 311.

This has the effect that the rotor 313 of the low-pressure compressor 31 is displaced relative to the stator 312 of the low-pressure compressor 31, parallel to the axis X of the turbojet engine 1, downstream in the flow direction of the air.

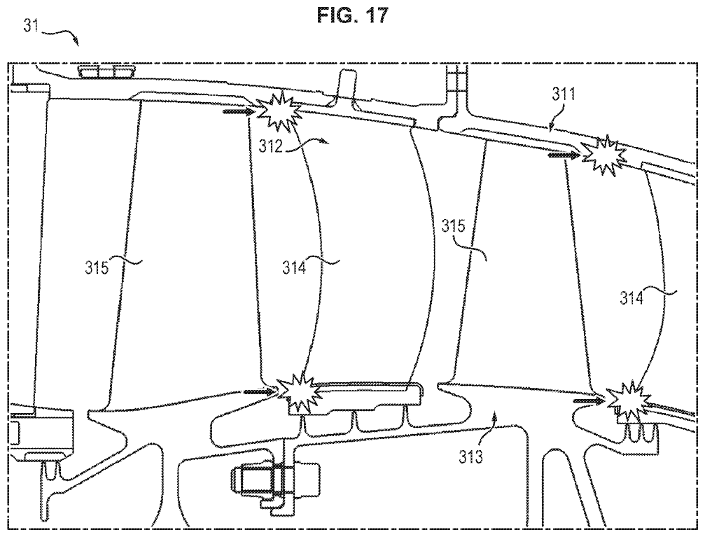

As illustrated in FIG. 17, with a conventional low-pressure compressor arrangement, there would be a risk that the blades 315 of the rotor 313 of the low-pressure compressor 31 will abut against the blades 314 of the stator 312 and/or against the casing 311 of the low-pressure compressor 31, which would greatly degrade the aerodynamic performance of the low-pressure compressor and therefore that of the turbojet engine.

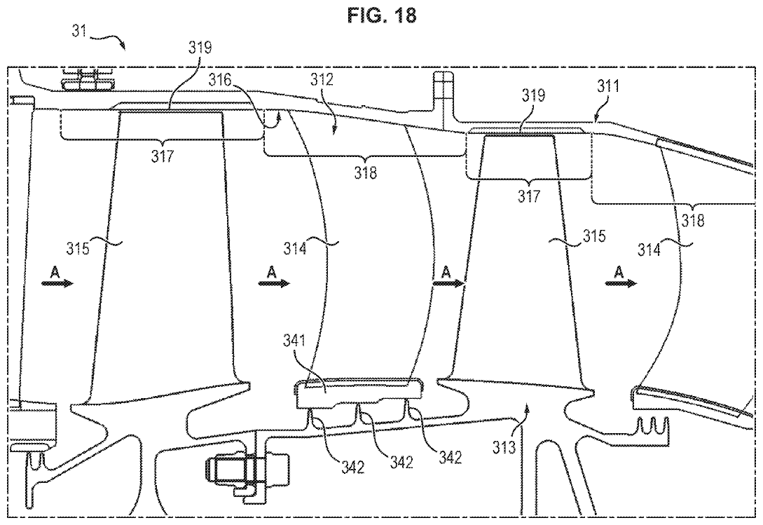

To overcome this problem, in the embodiments illustrated in FIGS. 18 to 20, the blades 315 of the rotor 313 are positioned relative to the blades 314 of the stator 312 so as to allow an axial displacement (parallel to the axis X) of the blades 315 of the rotor 313, downstream of the turbojet engine 1 in the flow direction of the air, within a displacement range comprised between 1 millimeter and 2 centimeters, preferably between 2 millimeters and 1 centimeter.

In addition, according to a first possibility illustrated in FIG. 18, the inner surface 316 of the low-pressure compressor casing 311 has, between the stationary blades 314, surface portions 317 of cylindrical shape of revolution, having the axis of rotation X of the low-pressure shaft as the axis of revolution.

Each surface portion 317 allows the axial displacement of a rotor blade 315 relative to the low-pressure compressor casing 311.

On the other hand, the inner surface 316 of the low-pressure compressor casing 311 may have, at the location where the blades 314 of the stator are fixed, non-cylindrical surface portions 318 of revolution.

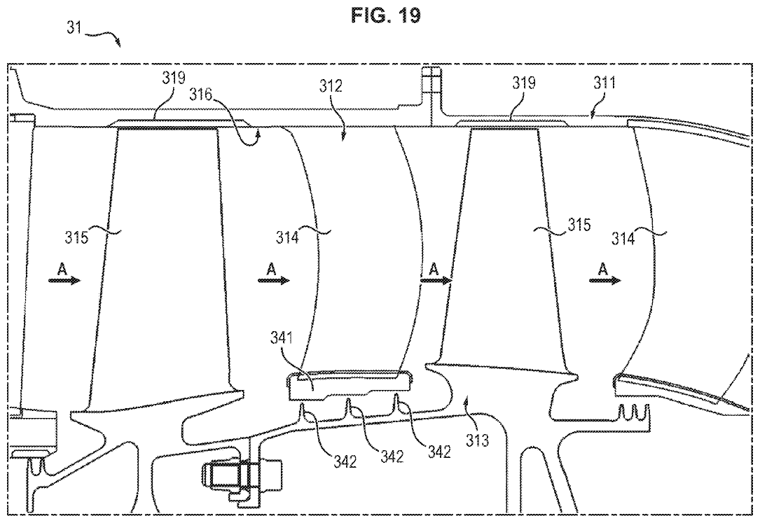

According to a second possibility illustrated in FIGS. 19 and 20, the entire inner surface 316 of the low-pressure compressor casing 311 has a cylindrical shape of revolution, having the axis of rotation X of the low-pressure shaft as the axis of revolution.

The inner surface 316 also allows the axial displacement of the rotor blades 314 relative to the low-pressure compressor casing 311.

In addition, as illustrated in FIGS. 18 to 20, abradable-material coatings 319 are provided on the inner surface 316 of the low-pressure compressor casing 311, facing the free end edges of the rotor blades 315. Each abradable-material coating 319 is dimensioned so as to be able to be dug by the end edge of the blade 315 located opposite thereto, during an axial displacement of said blade.

Similarly, each stator blade 314 is provided with a bead 343 1 formed of an abradable material fixed to the free end edge of the blade, and the rotor 313 is provided with wipers 342 disposed facing the bead 341. Each abradable-material bead 341 of is dimensioned so as to be able to be dug by the wipers 342, during an axial displacement of the rotor 313 relative to the stator 312.

Furthermore, in order to allow an axial displacement of the low-pressure shaft 33 relative to the reduction gearing 7, several solutions are possible.

According to a first possibility, the low-pressure shaft 33 is coupled with the input shaft of the reduction gearing via a coupling allowing a translation of the low-pressure shaft 33 relative to the input shaft of the reduction gearing 7.

Particularly, a solution consists in providing the upstream end of the low-pressure shaft 33 and the end of the input shaft of the reduction gearing 7 with longitudinal splines, the splines of the input shaft of the reduction gearing 7 cooperating with the splines of the low-pressure shaft 33 so as to secure the two shafts in rotation while allowing a translation of one relative to the other. The splines can be ball splines.

According to a second possibility, the reduction gearing 7 can comprise an epicyclic gearing designed to allow a displacement of its inner sun gear or of its outer sun gear relative to the satellites, for example thanks to straight teeth.

In addition, as illustrated in FIG. 20, the rotor 313 of the low-pressure compressor 31 comprises a series of discs 343. Each disc 343 has a central circular bore. The “upstream disc” is defined as the disc 343 located most upstream relative to the other discs 343, in the flow direction of the air flow (arrow A). The radius D1 of the bore of the upstream disc 343 is defined as the smallest distance between the longitudinal axis X of the turbojet engine 1 and the upstream disc 343.

If the first bearing BP#1 consists of a ball bearing 350, the radius D2 of the first bearing BP#1 is defined as the distance between the longitudinal axis X of the turbojet engine 1 and the center of a ball 353 of the ball bearing 350.

The radii D1 and D2 satisfy the following condition: D2>0.70×D1, and preferably D2>0.75×D1.

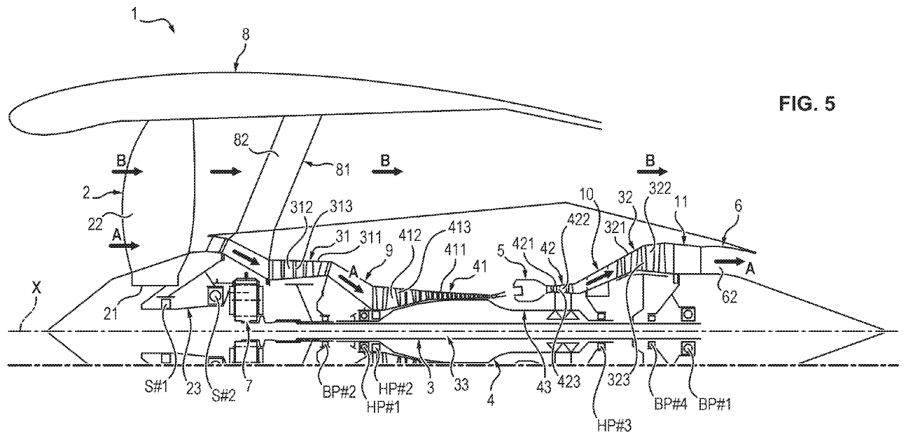

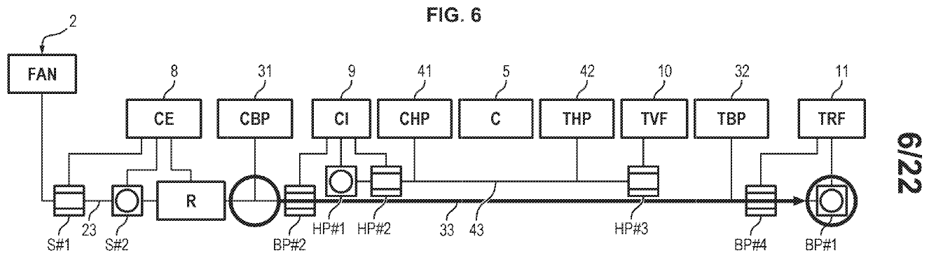

FIGS. 5 and 6 schematically show a twin-spool turbojet engine in accordance with a second embodiment of the invention.

This second embodiment is identical to the first embodiment, except for the following characteristics:

The turbojet engine 1 does not comprise a third bearing BP#3 disposed between the low-pressure shaft 33 and the inter-turbine casing 10.

Instead, the turbojet engine comprises a fourth bearing BP#4 disposed between the low-pressure shaft 33 and the exhaust casing 11, upstream of the bearing BP#1.

More specifically, the bearing BP#4 comprises an inner ring fastened on the low-pressure shaft 33, an outer ring fastened on the exhaust casing 11 and rollers disposed between the inner ring and the outer ring.

The bearing BP#4 is capable of withstanding the radial forces exerted on the low-pressure shaft 33 while allowing a certain axial displacement of the low-pressure shaft 33 relative to the exhaust casing 11. This means that the bearing BP#4 does not transmit any axial force exerted on the low-pressure shaft 33 to the casings.

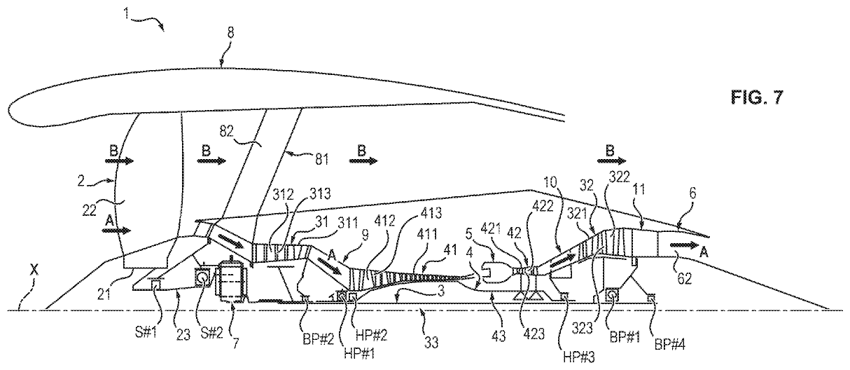

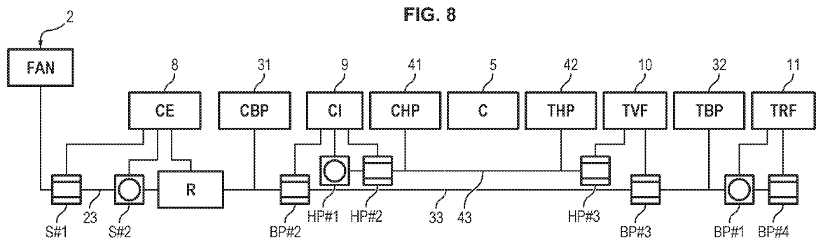

FIGS. 7 and 8 schematically show a twin-spool turbojet engine in accordance with a third embodiment of the invention.

This third embodiment is identical to the second embodiment, except for the following characteristics:

The fourth bearing BP#4 is disposed between the low-pressure shaft 33 and the exhaust casing 11, downstream of the bearing BP#1.

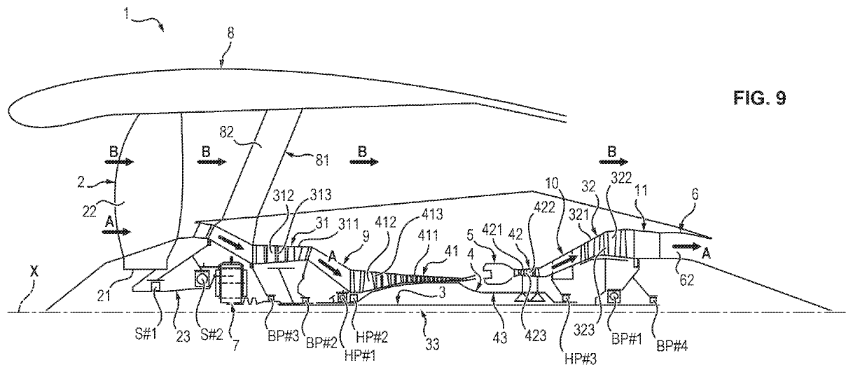

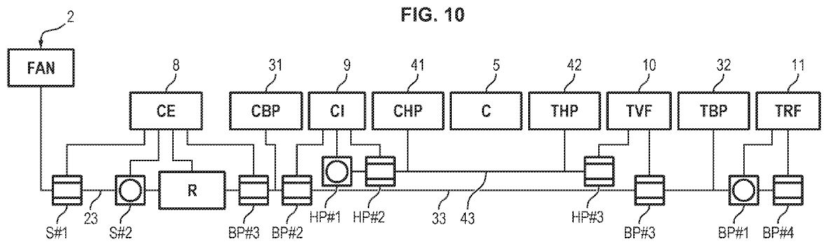

FIGS. 9 and 10 schematically show a twin-spool turbojet engine in accordance with a fourth embodiment of the invention.

This fourth embodiment is identical to the third embodiment, except for the following characteristics:

The turbojet engine 1 comprises a third bearing BP#3 disposed between the low-pressure shaft 33 and the inlet casing 8 (in the proximity of the upstream end of the low-pressure shaft).

The bearing BP#3 is capable of withstanding the radial forces exerted on the low-pressure shaft 33 while allowing a certain axial displacement of the low-pressure shaft 33 relative to the inlet casing 8. This means that the bearing BP#3 does not transmit any axial force exerted on the low-pressure shaft 33 to the casings.

In this fourth embodiment, the turbojet engine 1 thus comprises four bearings BP#1 to BP#4 supporting the low-pressure shaft 33: a first bearing BP#1 disposed between the low-pressure shaft 33 and the exhaust casing 11, a second bearing BP#2 disposed between the low-pressure shaft 33 and the inter-compressor casing 9, a third bearing BP#3, disposed between the low-pressure shaft 33 and the inlet casing 8 (in the proximity of the upstream end of the low-pressure shaft), and a fourth bearing BP#4, disposed between the low-pressure shaft 33 and the exhaust casing 11, downstream of the first bearing BP#1.

Only the first bearing BP#1 is a “thrust” bearing, that is to say it is capable of withstanding the axial forces exerted (downstream) by the low-pressure turbine 3 on the low-pressure shaft 33.

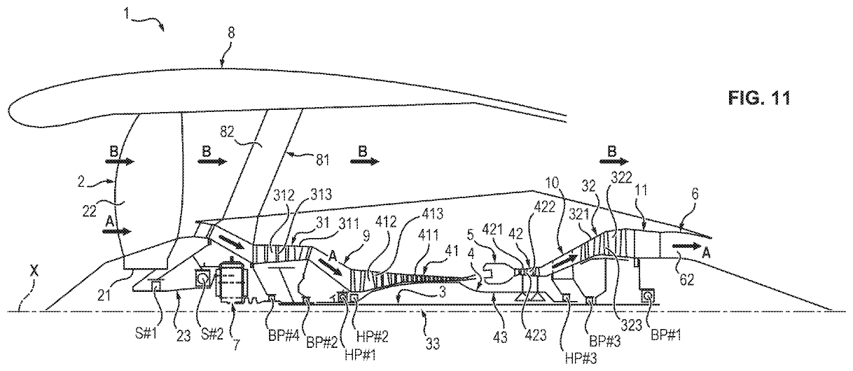

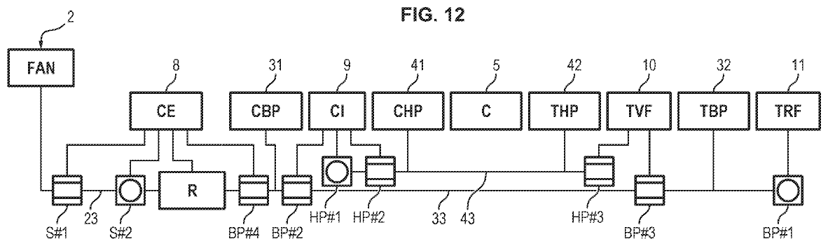

FIGS. 11 and 12 schematically show a twin-spool turbojet engine according to a fifth embodiment of the invention.

This fifth embodiment is identical to the first embodiment, except for the following characteristics:

The turbojet engine 1 comprises a fourth bearing BP#4 disposed between the low-pressure shaft 33 and the inlet casing 8 (in the proximity of the upstream end of the low-pressure shaft), upstream of the second bearing BP#2.

In this fifth embodiment, the turbojet engine 1 thus comprises four bearings BP#1 to BP#4 supporting the low-pressure shaft 33: a first bearing BP#1 disposed between the low-pressure shaft 33 and the exhaust casing 11, a second bearing BP#2 disposed between the low-pressure shaft 33 and the inter-compressor casing 9, a third bearing BP#3, disposed between the low-pressure shaft 33 and the inter-turbine casing 10, upstream of the first bearing BP#1, and a fourth bearing BP#4, disposed between the low-pressure shaft 33 and the inlet casing 8 (in the proximity of the upstream end of the low-pressure shaft).

Only the first bearing BP#1 is a “thrust” bearing, that is to say it is capable of withstanding the axial forces exerted (downstream) by the low-pressure turbine 3 on the low-pressure shaft 33.

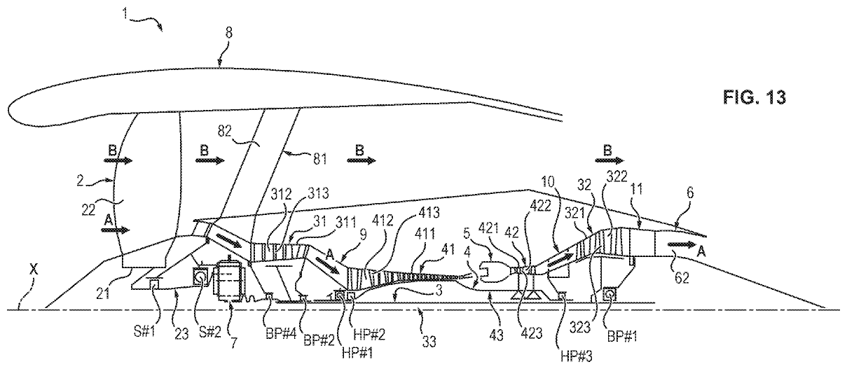

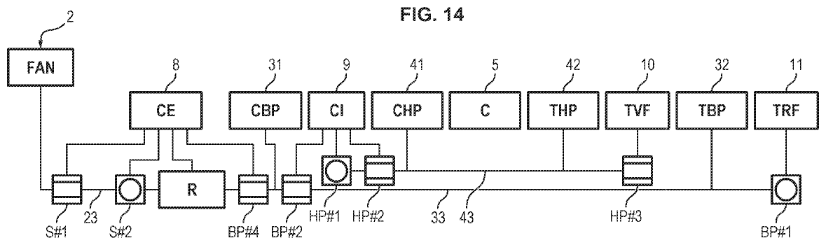

FIGS. 13 and 14 schematically show a twin-spool turbojet engine according to a sixth embodiment of the invention.

This sixth embodiment is identical to the fourth embodiment, except for the following characteristics:

The turbojet engine 1 does not comprise a third bearing BP#3 disposed between the low-pressure shaft 33 and the inter-turbine casing 10.

In this sixth embodiment, the turbojet engine 1 thus comprises three bearings BP#1, BP#2 and BP#4 supporting the low-pressure shaft 33: a first bearing BP#1 disposed between the low-pressure shaft 33 and the exhaust casing 11, a second bearing BP#2 disposed between the low-pressure shaft 33 and the inter-compressor casing 9, and a fourth bearing BP#4, disposed between the low-pressure shaft 33 and the inlet casing 8 (in the proximity of the upstream end of the low-pressure shaft).

Only the first bearing BP#1 is a “thrust” bearing, that is to say it is capable of withstanding the axial forces exerted (downstream) by the low-pressure turbine 3 on the low-pressure shaft 33.

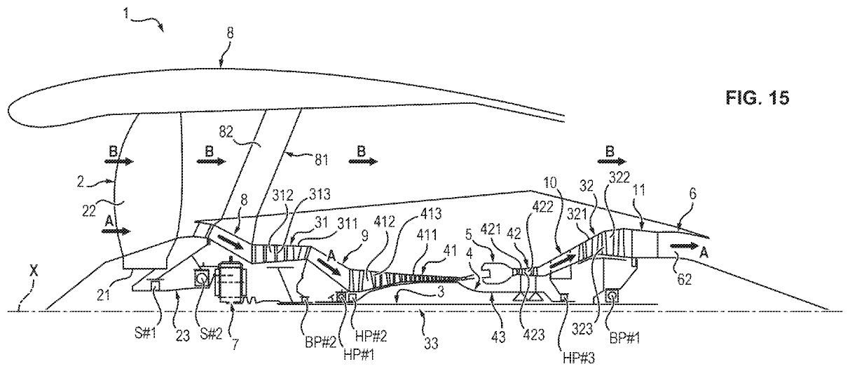

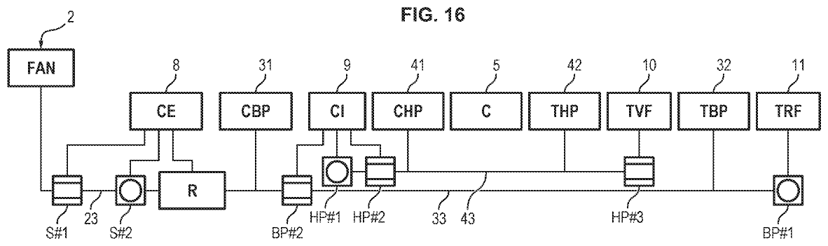

FIGS. 15 and 16 schematically show a twin-spool turbojet engine in accordance with a seventh embodiment of the invention.

This seventh embodiment is identical to the sixth embodiment, except for the following characteristics:

The turbojet engine 1 does not comprise a fourth bearing BP#4 disposed between the low-pressure shaft 33 and the inlet casing 8.

In this seventh embodiment, the turbojet engine 1 thus comprises two bearings BP#1 and BP#2 supporting the low-pressure shaft 33: the first bearing BP#1 disposed between the low-pressure shaft 33 and the exhaust casing 11 and the second bearing BP#2 disposed between the low-pressure shaft 33 and the inter-compressor casing 9.

The first bearing BP#1 is a “thrust” bearing, that is to say it is capable of withstanding the axial forces exerted (downstream) by the low-pressure turbine 3 on the low-pressure shaft 33. The second bearing BP#2 is capable of withstanding the radial forces exerted on the low-pressure shaft 33 while allowing a certain axial displacement of the low-pressure shaft 33 relative to the inter-compressor casing 9. This means that the bearing BP#2 does not transmit any axial force exerted on the low-pressure shaft 33 to the casings.

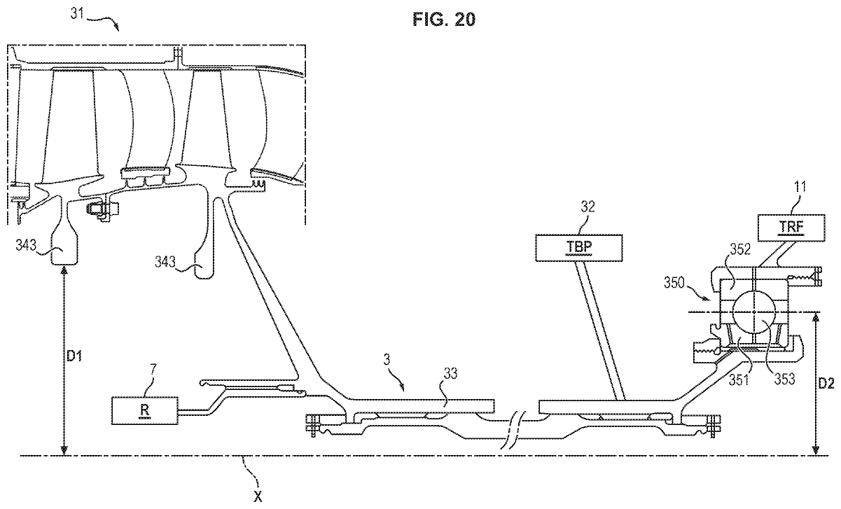

FIG. 21 schematically shows a twin-spool turbojet engine according to an eighth embodiment of the invention.

In this embodiment, the low-pressure shaft 33 is formed in two portions. Indeed, the low-pressure shaft 33 comprises a low-pressure shaft upstream portion 331, a low-pressure shaft downstream portion 332 and a coupling assembly 333 connecting the low-pressure shaft downstream portion 332 and the low-pressure shaft upstream portion 331 to one another.

The coupling assembly 333 can be positioned in the proximity of the upstream end of the low-pressure shaft 33 (position referenced 333-a in FIG. 21) or in the proximity of the downstream end of the low-pressure shaft 33 (position referenced 333-b in FIG. 21). The coupling assembly is adapted to transmit a torque between the low-pressure shaft downstream portion 332 and the low-pressure shaft upstream portion 331, while allowing a relative axial displacement between the low-pressure shaft downstream portion 332 and the low-pressure shaft upstream portion 331 due to the expansion of some portions of the turbojet engine 1.

In this embodiment, the low-pressure shaft 33 is supported by four bearings, including a first bearing BP#1, a second bearing BP#2, a third bearing BP#3 and a fourth bearing BP#4.

The first bearing BP#1 is disposed between the downstream portion of the low-pressure shaft 332 and the exhaust casing 11. The first bearing BP#1 is a “thrust” bearing, that is to say it is capable of transmitting the axial forces exerted on the low-pressure shaft upstream portion 331.

To this end, the thrust bearing BP#1 comprises an inner ring fastened on the low-pressure shaft downstream portion 332, an outer ring fastened on the exhaust casing 11 and balls or conical rollers disposed between the inner ring and the outer ring.

The fourth bearing BP#4 is disposed between the low-pressure shaft upstream portion 331 and the inlet casing 8. The fourth bearing BP#4 is also a “thrust” bearing, that is to say it is capable of withstanding axial forces.

To this end, the thrust bearing BP#4 comprises an inner ring fastened on the low-pressure shaft upstream portion 331, an outer ring fastened on the inlet casing 8 and balls or conical rollers disposed between the inner ring and the outer ring.

In this embodiment, the bearing BP#4 prevents any relative axial displacement between the upstream end of the low-pressure shaft 33 and the inlet casing 8, while the bearing BP#1 prevents any relative axial displacement between the downstream end of the low-pressure shaft 33 and the exhaust casing 11.

However, the coupling assembly 333 allows a relative axial displacement between the low-pressure shaft downstream portion 332 and the low-pressure shaft upstream portion 331.

The second bearing BP#2 can be disposed between the low-pressure shaft 33 and the inter-compressor casing 9.

The third bearing BP#3 is disposed between the low-pressure shaft 33 and the exhaust casing 11.

The second bearing BP#2 and the third bearing BP#3 are capable of withstanding the radial forces exerted on the low-pressure shaft 33 while allowing a certain axial displacement of the low-pressure shaft 33 relative to the inter-compressor casing 9 and to the exhaust casing. This means that the bearings BP#2 and BP#3 do not transmit any axial force exerted on the low-pressure shaft 33 to the casings.

According to a first possibility illustrated in FIG. 21, the coupling assembly 333 is positioned in the proximity of the upstream end of the low-pressure shaft 33 (in this position, the coupling assembly is referenced 333-a in FIG. 21). In this case, the coupling assembly 333 is disposed downstream of the junction between the low-pressure shaft 33 and the rotor 313 of the low-pressure compressor 31.

According to a second possibility illustrated in FIG. 21, the coupling assembly 333 is positioned in the proximity of the downstream end of the low-pressure shaft 33 (in this position, the coupling assembly is referenced 333-b). In this case, the coupling assembly 333 is disposed upstream of the junction between the low-pressure shaft 33 and the rotor 323 of the low-pressure turbine 32.

In this embodiment, the bearing BP#4 can be dimensioned so as to have a space requirement less than the bearing BP#1 of a conventional twin-spool turbojet engine as shown in FIGS. 1 and 2. Particularly, the bearing BP#4 may have a reduced external diameter and/or balls having a reduced diameter.

Indeed, the take-up of the axial forces exerted on the low-pressure shaft 33 is distributed between the bearing BP#1 and the bearing BP#4. Particularly, the bearing BP#4 does not take-up the axial forces exerted on the low-pressure shaft 33 by the low-pressure turbine 32.

Due to its reduced space requirement, the fourth bearing BP#4 can be disposed in the center of the low-pressure compressor 31. The low-pressure compressor 31 can comprise rotor discs 343 having a reduced bore radius. It is thus possible to optimize the shape of the discs to reduce their weight and/or reduce the internal diameter of the compressor flow path.

Furthermore, in this embodiment, the turbojet engine 1 comprises a conventional low-pressure compressor casing such as that shown in FIG. 17. Indeed, the bearing BP#4 prevents any axial displacement (parallel to the axis X) of the rotor 313 blades 315 of the low-pressure compressor 31 relative to the stator 312 blades 314 or relative to the casing 311 of the low-pressure compressor 31.

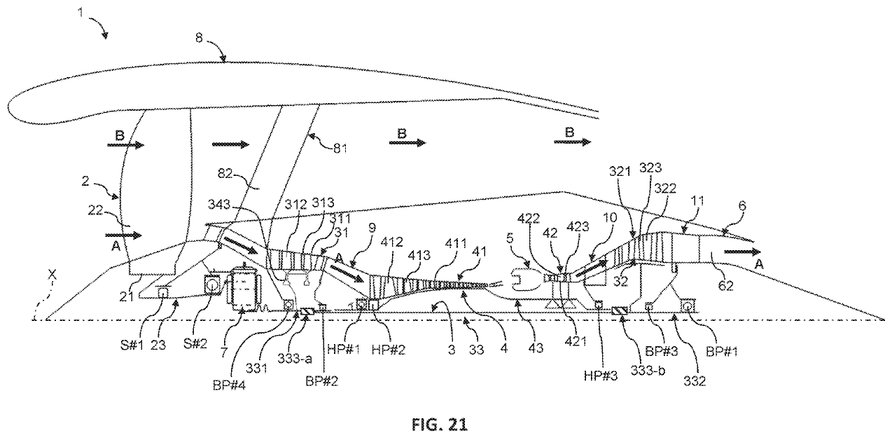

FIG. 22 schematically shows a first example of a coupling assembly 333 allowing to connect the low-pressure shaft downstream portion 331 and the low-pressure shaft upstream portion 332 to each other.

In this example, the low-pressure shaft upstream portion 331 comprises an inner surface 335 and the low-pressure shaft downstream portion 332 comprises an outer surface 336. The inner surface 335 may have a cylindrical shape of revolution having the axis X as the axis of revolution. Similarly, the outer surface 336 may have a cylindrical shape of revolution having the axis X as the axis of revolution. The inner surface 335 surrounds the outer surface 336. Of course, it would also be possible to design a coupling assembly 333 in which the low-pressure shaft upstream portion 331 comprises an outer surface and the low-pressure shaft downstream portion 332 comprises an inner surface surrounding the outer surface of the low-pressure shaft upstream portion 331.

The inner surface 335 has first axial splines. Similarly, the outer surface 336 has second axial splines extending facing the first axial splines.

The coupling assembly 333 further comprises a plurality of rolling elements 337 (for example balls) interposed between the inner surface 335 and the outer surface 336. Each rolling element 337 extends both in one of the first splines and in one of the second splines. The rolling elements 337 are capable of transmitting a torque between the low-pressure shaft downstream portion 332 and the low-pressure shaft upstream portion 331, while allowing an axial displacement of one relative to the other parallel to the axis X.

The coupling assembly 333 comprises a cage 338 disposed between the inner surface 335 and the outer surface 336. The cage 338 comprises a plurality of openings, each opening receiving one of the rolling elements 337 to keep the rolling elements 337 spaced apart from each other.

The coupling assembly can be a coupling assembly in accordance with that described in the patent application FR no 1854044 filed on May 15, 2018 filed in the name of Safran Aircraft Engines, which is incorporated herein by reference.

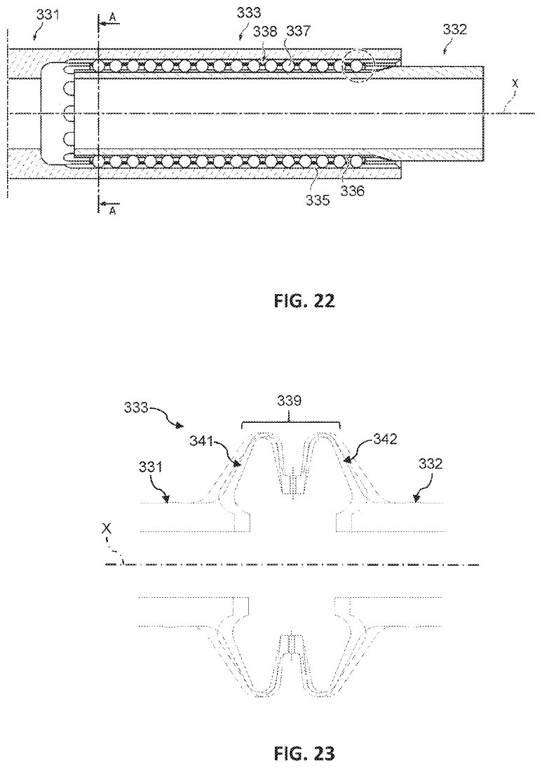

FIG. 23 schematically shows a second example of a coupling assembly 333.

In this example, the coupling assembly 333 comprises a bellows junction portion 339. The bellows junction portion 339 connects the low-pressure shaft upstream portion 331 to the low-pressure shaft downstream portion 332. The bellows junction portion 339 comprises a plurality of bellows capable of deforming to allow a relative axial displacement between the low-pressure shaft upstream portion 331 and the low-pressure shaft downstream portion 332 parallel to the axis X, while preventing a relative rotation between the low-pressure shaft upstream portion 331 and the low-pressure shaft downstream portion 332 about the axis X.

In the example illustrated in FIG. 22, the bellows junction portion 339 comprises a first bellows 341 and a second bellows 342.

In FIG. 22, the bellows junction portion 339 was shown in solid lines in a first position (or retracted position) and in dotted lines in a second position (or stretched position).

1. A twin-spool turbojet engine comprising;
a low-pressure spool, comprising a low-pressure compressor, a low-pressure turbine and a low-pressure shaft connecting the low-pressure turbine to the low-pressure compressor;
a high-pressure spool, comprising a high-pressure compressor, a high-pressure turbine and a high-pressure shaft connecting the high-pressure turbine to the high-pressure compressor, the low-pressure shaft extending inside the high-pressure shaft;
a fan shaft;
a reduction mechanism coupling the low-pressure shaft and the fan shaft;
an exhaust casing through which exhaust gases flow downstream of the low-pressure turbine; and
a low-pressure shaft thrust bearing comprising an inner ring and an outer ring, one of the rings being fastened on the low-pressure shaft and the other of the rings being fastened on the exhaust casing.

2. The turbojet engine according to claim 1, further comprising at most two additional low-pressure shaft bearings, each additional low-pressure shaft bearing comprising an inner ring and an outer ring, one of the rings being fastened on the low-pressure shaft and the other of the rings being fastened on a casing of the turbojet engine.

3. The turbojet engine according to claim 1, further comprising a single additional low-pressure shaft bearing, the additional low-pressure shaft bearing comprising an inner ring and an outer ring, one of the rings being fastened on the low-pressure shaft and the other of the rings being fastened on a casing of the turbojet engine.

4. The turbojet engine according to claim 2, wherein each additional low-pressure shaft bearing comprises an inner ring or an outer ring fastened on an inter-compressor casing or an inter-turbine casing of the turbojet engine.

5. The turbojet engine according to claim 1, wherein the low-pressure compressor comprises:
a low-pressure compressor casing having an inner surface delimiting a flow path of an air flow through the low-pressure compressor,
a stator comprising blades mounted stationary relative to the low-pressure compressor casing and extending in the flow path of the air flow, and
a rotor comprising movable blades capable of being driven in rotation relative to the stator by the low-pressure shaft, the movable blades extending in the flow path of the air flow while being interposed between the stationary blades,
wherein the inner surface of the low-pressure compressor casing, the stationary blades and the movable blades are disposed relative to each other so as to allow an axial displacement of the movable blades relative to the stationary blades parallel to the axis of rotation of the low-pressure shaft.

6. The turbojet engine according to claim 5, wherein the authorized axial displacement is comprised between 1 millimeter and 2 centimeters.

7. The turbojet engine according to claim 5, wherein the inner surface of the low-pressure compressor casing has, between the stationary blades, portions of cylindrical shape of revolution, having the axis of rotation of the low-pressure shaft as the axis of revolution.

8. The turbojet engine according to claim 5, wherein the inner surface of the low-pressure compressor casing has a cylindrical shape of revolution, having the axis of rotation of the low-pressure shaft as the axis of revolution.

9. The turbojet engine according to claim 1, wherein the low-pressure shaft has an upstream end provided with splines and the reduction mechanism comprises an input shaft having an end provided with splines, the splines of the input shaft of the reduction mechanism cooperating with the splines of the low-pressure shaft so as to secure the two shafts in rotation while allowing a translation of one of the shafts relative to the other.

10. The turbojet engine according to claim 1, wherein the low-pressure compressor comprises an upstream disc of a low-pressure compressor having a bore having a first radius, and wherein the first low-pressure shaft thrust bearing has a second radius such that: D2>0.70×D1, where D1 is the first radius and D2 is the second radius.

11. The turbojet engine according to claim 1, further comprising a second low-pressure shaft thrust bearing comprising an inner ring and an outer ring, one of the rings being fastened on the low-pressure shaft and the other of the rings being fastened on the inlet casing.

12. The turbojet engine according to claim 11, wherein the low-pressure shaft comprises a low-pressure shaft upstream portion, a low-pressure shaft downstream portion, and a coupling assembly adapted to transmit a torque between the low-pressure shaft upstream portion and the low-pressure shaft downstream portion while allowing a relative axial displacement between the low-pressure shaft upstream portion and the low-pressure shaft downstream portion.
